(19) United States
(12) Patent Application Publication
(10) Pub. No.: US 2001/0002639 A1
(43) Pub. Date: Jun. 7, 2001

(54) Solenoid apparatus for use in hydraulic shock absorber

(76) Inventor: Takashi Nezu, Tokyo (JP)

Correspondence Address: WENDEROTH, LIND & PONACK, L.L.P., 2033 K Street, N.W., Suite 800, Washington, DC, 20006, US

(21) Appl. No.: 09/730,765

(22) Filed: Dec. 7, 2000

(30) Foreign Application Priority Data
Dec. 7, 1999 (JP) 347553/1999

(51) Int. Cl. F16F 9/44

(52) U.S. Cl. 188/319.1; 60/685

(57) ABSTRACT

In a disclosed solenoid apparatus, one end of an actuating rod secured to the plunger of the solenoid apparatus abuts on a slider equipped with extension and compression pressure control valves. A coil is excited to induce thrust in the plunger, thereby moving the slider to control damping force. An end of the actuating rod projects from the plunger and extends through a rod guide to form a hydraulic fluid chamber at the rear of the plunger. Hydraulic fluid chambers inside the hydraulic shock absorber are communicated directly with the hydraulic fluid chamber at the rear of the plunger through hydraulic fluid passages in the actuating rod. Even when there is a sharp change in the pressure in the hydraulic fluid chambers inside the hydraulic shock absorber, the pressures acting on both ends of the plunger are kept equal to each other at all times.

### BACKGROUND OF THE INVENTION

The present invention relates to a solenoid apparatus provided in a hydraulic shock absorber attached to a suspension system of a vehicle or the like to change an operational status of a damping force control valve.

There are hydraulic shock absorbers arranged to allow damping force to be controlled appropriately. One type of such hydraulic shock absorbers has a solenoid apparatus accommodated in a piston rod or in a damping force control mechanism installed on a side portion of a cylinder. The solenoid apparatus changes an operational status of a damping force control valve according to an electric current externally supplied to the coil of the solenoid apparatus.

In general, a solenoid apparatus incorporated in a hydraulic shock absorber has a movable core immersed in a hydraulic fluid sealed in the hydraulic shock absorber. Hydraulic fluid chambers formed at both ends of the movable core are communicated with each other through a hydraulic fluid passage provided in the movable core to keep a balance between the pressures of hydraulic fluid acting on the two ends of the movable core, thereby minimizing the influence of a change in the pressure of hydraulic fluid in the hydraulic shock absorber and thus reducing the load on the solenoid apparatus. In addition, an orifice is provided in the hydraulic fluid passage in the movable core to exert appropriate damping force against the movement of the movable core by the flow resistance of the orifice, thereby suppressing self-induced vibration of the movable core and also suppressing the movement of the movable core due to disturbance with a view to obtaining stable damping force.

However, the above-described conventional solenoid apparatus for a hydraulic shock absorber, in which the movable core is provided with a hydraulic fluid passage and an orifice, suffers from the following problem. When the pressure of hydraulic fluid in the hydraulic shock absorber changes sharply owing to a change in the stroke direction of the piston rod or the like, the pressure is transmitted through the hydraulic fluid passage and orifice provided in the movable core to the hydraulic fluid chamber at the rear of the movable core. Because the hydraulic fluid chamber at the rear of the movable core has slight elasticity of volume derived from the elasticity of an O-ring provided at the seal portion or the like, and there is a delay in transmission of the pressure through the orifice, a pressure difference produced between the hydraulic fluid chambers at the two ends of the movable core may cause the movable core to move undesirably. In such a case, the movable core causes chattering, and it becomes difficult to obtain stable damping force.

### SUMMARY OF THE INVENTION

The present invention was made in view of the above-described circumstances. An object of the present invention is to provide a solenoid apparatus for use in a hydraulic shock absorber, which is capable of obtaining stable damping force by preventing undesired movement of the movable core due to a pressure change in the hydraulic shock absorber.

To attain the above-described object, the present invention provides a solenoid apparatus incorporated in a hydraulic shock absorber to actuate a damping force control valve by thrust of a movable core movable in response to excitation of a coil. In the solenoid apparatus, a hydraulic fluid chamber at the rear of the movable core is communicated directly with a hydraulic fluid chamber in the hydraulic shock absorber through a hydraulic fluid passage, whereby the pressures of hydraulic fluid acting on both ends of the movable core are kept equal to each other at all times.

With the above-described arrangement, even when there is a sharp change in the pressure in the hydraulic fluid chamber inside the hydraulic shock absorber, the pressure is transmitted directly to the hydraulic fluid chamber at the rear of the movable core through the hydraulic fluid passage. Therefore, there will be no delay in transmission of the pressure, and the pressures of hydraulic fluid acting on both ends of the movable core are always kept equal to each other. Accordingly, there will be no undesired movement of the movable core due to a pressure difference.

The solenoid apparatus according to the present invention having the above-described arrangement may be provided with a damping device for exerting damping force against the movement of the movable core.

With the above-described arrangement, the movement of the movable core is damped by the damping device.

The above and other objects, features and advantages of the present invention will become more apparent from the following description of the preferred embodiments thereof, taken in conjunction with the accompanying drawing.

### BRIEF DESCRIPTION OF THE DRAWING

The attached sole figure is a vertical sectional view of an essential part of a damping force control type hydraulic shock absorber to which a solenoid apparatus according to an embodiment of the present invention is applied.

### DETAILED DESCRIPTION OF THE INVENTION

One embodiment of the present invention will be described below in detail with reference to the accompanying drawing.

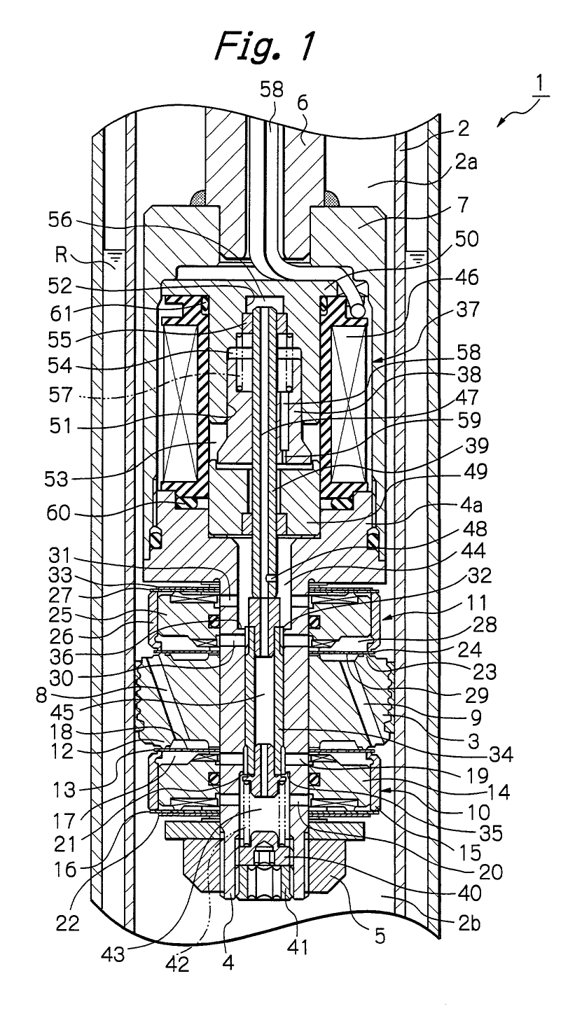

FIG. 1 shows a damping force control type hydraulic shock absorber 1 to which a solenoid apparatus according to an embodiment of the present invention is applied. As shown in FIG. 1, the damping force control type hydraulic shock absorber 1 includes a cylinder 2 having a hydraulic fluid sealed therein. A piston 3 is slidably fitted in the cylinder 2. The piston 3 divides the inside of the cylinder 2 into two chambers, i.e. a cylinder upper chamber 2a and a cylinder lower chamber 2b. An approximately cylindrical piston bolt 4 is inserted into the piston 3, and the piston 3 is secured to the piston bolt 4 by using a nut 5. The piston bolt 4 has a large-diameter portion 4a at the proximal end thereof. A solenoid casing 7 connected to one end portion of a hollow piston rod 6 is screwed onto the large-diameter portion 4a of the piston bolt 4. The other end portion of the piston rod 6 extends through the cylinder upper chamber 2a and further through a rod guide (not shown) and an oil seal (not shown), which are fitted to the upper end portion of the cylinder 2, and further extends to the outside of the cylinder 2. It should be noted that a reservoir R having the hydraulic fluid and a gas sealed therein is communicated with the cylinder 2 through a base valve (not shown) to compensate for a volumetric change in the cylinder 2 due to extension and contraction of the piston rod 6.

The piston 3 is provided with an extension hydraulic fluid passage 8 and a compression hydraulic fluid passage 9 for communication between the cylinder upper and lower chambers 2a and 2b. An extension damping force generating mechanism 10 is provided between the piston 3 and the nut 5 to control the flow of hydraulic fluid in the extension hydraulic fluid passage 8. A compression damping force generating mechanism 11 is provided between the piston 3 and the large-diameter portion 4a of the piston bolt 4 to control the flow of hydraulic fluid in the compression hydraulic fluid passage 9.

The extension damping force generating mechanism 10 will be described below. An annular valve seat 12 projects from an end surface of the piston 3 that faces the cylinder lower chamber 2b. A disk valve 13 is seated on the valve seat 12. An annular fixed member 14 is mounted on the piston bolt 4 between the piston 3 and the nut 5. A movable ring 15 is slidably fitted on the outer periphery of the fixed member 14. The movable ring 15 is pressed to abut on the disk valve 13 by spring force of a disk-shaped plate spring 16 clamped between the fixed member 14 and the nut 5. A pilot chamber 17 is formed between the disk valve 13 and the fixed member 14 so that the pressure in the pilot chamber 17 acts on the disk valve 13 in the direction for closing it. The pilot chamber 17 is communicated with the extension hydraulic fluid passage 8 through a fixed orifice 18 provided in the disk valve 13. The pilot chamber 17 is also communicated with the other side of the fixed member 14 by ports 19 and 20 provided in the side wall of the piston bolt 4 through an extension pressure control valve 21 provided inside the piston bolt 4. The pilot chamber 17 is further communicated with the cylinder lower chamber 2b through a check valve 22 formed from a disk valve superimposed on the plate spring 16.

The compression damping force generating mechanism 11 will be described below. An annular valve seat 23 projects from an end surface of the piston 3 that faces the cylinder upper chamber 2a. A disk valve 24 is seated on the valve seat 23. An annular fixed member 25 is mounted on the piston bolt 4 between the large-diameter portion 4a and the piston 3. A movable ring 26 is slidably fitted on the outer periphery of the fixed member 25. The movable ring 26 is pressed to abut on the disk valve 24 by spring force of a disk-shaped plate spring 27 clamped between the fixed member 25 and the large-diameter portion 4a. A pilot chamber 28 is formed between the disk valve 24 and the fixed member 25 so that the pressure in the pilot chamber 28 acts on the disk valve 24 in the direction for closing it. The pilot chamber 28 is communicated with the compression hydraulic fluid passage 9 through a fixed orifice 29 provided in the disk valve 24. The pilot chamber 28 is also communicated with the other side of the fixed member 25 by ports 30 and 31 provided in the side wall of the piston bolt 4 through a compression pressure control valve 32 provided inside the piston bolt 4. The pilot chamber 28 is further communicated with the cylinder upper chamber 2a through a check valve 33 formed from a disk valve superimposed on the plate spring 27.

The extension and compression pressure control valves 21 and 32 (damping force control valves) are formed from disk valves secured to both ends of a cylindrical slider 34 slidably fitted in the piston bolt 4. The extension and compression pressure control valves 21 and 32 are adapted to rest on respective valve seats 35 and 36. The valve seat 35 is formed between a pair of ports 19 and 20. The valve seat 36 is formed between a pair of ports 30 and 31. The extension and compression pressure control valves 21 and 32 open by receiving the pressure of hydraulic fluid from the upstream ports 19 and 30 to generate damping force. The damping force is controlled by moving the slider 34.

A proportional solenoid apparatus 37 is provided in the solenoid casing 7. An actuating rod 39 is connected to a plunger 38 (movable core) of the proportional solenoid apparatus 37. The distal end of the actuating rod 39 abuts on one end of the slider 34. An adjusting screw 40 and a lock nut 41 are screwed into the opening at the distal end of the piston bolt 4 to close the opening. A compression spring 42 is interposed between the adjusting screw 40 and the other end of the slider 34. A hydraulic fluid chamber 43 communicating with the port 20 is formed at the other end of the slider 34, which is closer to the adjusting screw 40. A hydraulic fluid chamber 44 communicating with the port 31 is formed at the one end of the slider 34, which is closer to the proportional solenoid apparatus 37. The hydraulic fluid chambers 43 and 44 are communicated with each other through a hydraulic fluid passage 45 provided in the slider 34 and further through axial and radial hydraulic fluid passages 47 and 48 provided in the actuating rod 39.

The proportional solenoid apparatus 37 has a cylindrical coil 46. A core 49 (fixed core) and a guide flange member 50 are fitted into both ends of the coil 46 and secured thereto. The guide flange member 50 has a large-diameter bore 51 and a small-diameter bore 52, which are formed in concentric relation to each other. The plunger 38 is slidably fitted in the large-diameter bore 51 to divide the inside of the coil 46 into two chambers, i.e. a hydraulic fluid chamber 53 that is closer to the fixed core 49, and a hydraulic fluid chamber 54 in the large-diameter bore 51. An annular rod guide 55 is press-fitted into the small-diameter bore 52 and secured thereto. The actuating rod 39 is press-fitted into the plunger 38 in such a manner that one end portion thereof projects from the plunger 38. The projecting end portion of the actuating rod 39 slidably extends through the core 49, and the distal end thereof abuts on the one end of the slider 34. The other end portion of the actuating rod 39 projects from the plunger 38 and slidably extends through the rod guide 55 in a fluid-tight manner to form a hydraulic fluid chamber 56 in the small-diameter bore 52. A compression spring 57 is interposed between the plunger 38 and the guide flange member 50. Lead wires 58 of the coil 46 extend through the hollow piston rod 6 to the outside of the cylinder 2.

Both end portions of the actuating rod 39 are equal in diameter to each other. Accordingly, the pressure-receiving areas with respect to the hydraulic fluid chambers 44 and 56 at the two ends of the actuating rod 39 are equal to each other. The hydraulic fluid chamber 56 is communicated with the hydraulic fluid passage 45 in the slider 34 through the axial hydraulic fluid passage 47 in the actuating rod 39 and also communicated with the hydraulic fluid chamber 44 through the radial hydraulic fluid passage 48. The hydraulic fluid passages 47 and 48 have a sufficiently large flow path area so that substantially no flow resistance is offered to the hydraulic fluid flowing through the hydraulic fluid passages 47 and 48. The plunger 38 is provided with a hydraulic fluid passage 58 for communication between the hydraulic fluid chambers 53 and 54 at both ends of the plunger 38. The hydraulic fluid passage 58 is provided with an orifice 59 (damping device). An end portion of the plunger 38 that faces the core 49 has an enlarged diameter to increase attraction force of the core 49, that is, thrust of the solenoid apparatus 37, and to reduce the size of the coil 46. The hydraulic fluid chambers 53, 54 and 56 inside the coil 46 are filled with the hydraulic fluid. The outside of the coil 46 is cut off from these hydraulic fluid chambers by seals 60 and 61 in a fluid-tight manner.

The following is a description of the operation of this embodiment arranged as stated above.

During the extension stroke of the piston rod 6, as the piston 3 moves, the hydraulic fluid in the cylinder upper chamber 2a is pressurized. Consequently, before the disk valve 13 of the extension damping force generating mechanism 10 opens (in a low piston speed region), the hydraulic fluid in the cylinder upper chamber 2a flows to the cylinder lower chamber 2b through the extension hydraulic fluid passage 8, the fixed orifice 18 in the disk valve 13, the pilot chamber 17, the port 19, the extension pressure control valve 21, the port 20 and the check valve 22. When the pressure in the cylinder upper chamber 2a reaches the valve opening pressure of the disk valve 13 (a high piston speed region), the disk valve 13 opens to allow the hydraulic fluid from the extension hydraulic fluid passage 8 to flow directly into the cylinder lower chamber 2b.

Thus, before the disk valve 13 opens (in the low piston speed region), damping force is generated by the fixed orifice 18 and the extension pressure control valve 21. At this time, according to the degree of opening of the extension pressure control valve 21, the pressure in the pilot chamber 17, which is on the upstream side of the extension pressure control valve 21, changes, and the pressure in the pilot chamber 17 acts on the disk valve 13 in the direction for closing it as a pilot pressure. Therefore, the valve opening pressure of the disk valve 13 can be controlled simultaneously by controlling the degree of opening of the extension pressure control valve 21. Thus, damping force in the high piston speed region can be controlled simultaneously.

During the compression stroke of the piston rod 6, as the piston 3 moves, the hydraulic fluid in the cylinder lower chamber 2b is pressurized. Consequently, before the disk valve 24 of the compression damping force generating mechanism 11 opens (in the low piston speed region), the hydraulic fluid in the cylinder lower chamber 2b flows to the cylinder upper chamber 2a through the compression hydraulic fluid passage 9, the fixed orifice 29 in the disk valve 24, the pilot chamber 28, the port 30, the compression pressure control valve 32, the port 31 and the check valve 33. When the pressure in the cylinder lower chamber 2b reaches the valve opening pressure of the disk valve 24 (the high piston speed region), the disk valve 24 opens to allow the hydraulic fluid from the compression hydraulic fluid passage 9 to flow directly into the cylinder upper chamber 2a.

Thus, before the disk valve 24 opens (in the low piston speed region), damping force is generated by the fixed orifice 29 and the compression pressure control valve 32. At this time, according to the degree of opening of the compression pressure control valve 32, the pressure in the pilot chamber 28, which is on the upstream side of the compression pressure control valve 32, changes, and the pressure in the pilot chamber 28 acts on the disk valve 24 in the direction for closing it as a pilot pressure. Therefore, the valve opening pressure of the disk valve 24 can be controlled simultaneously by controlling the degree of opening of the compression pressure control valve 32. Thus, damping force in the high piston speed region can be controlled simultaneously.

The degree of opening of each of the extension and compression pressure control valves 21 and 32 can be controlled by positioning the slider 34 with the proportional solenoid apparatus 37. When an electric current is externally supplied to the coil 46 through the lead wires 58, a magnetic field is produced according to the supplied electric current. Consequently, the core 49 attracts the plunger 38, inducing thrust in the actuating rod 39 in proportion to the supplied electric current, and thus causing the slider 34 to be pressed downward. The position of the slider 34 can be determined by the balance between the thrust and spring forces of the springs 42 and 57 and further the pressure of the hydraulic fluid. Thus, it is possible to control the degree of opening of each of the extension and compression pressure control valves 21 and 32.

When the slider 34 is placed in an intermediate position where both the extension and compression pressure control valves 21 and 32 are open, “soft” damping force characteristics (small damping force) can be obtained during both the extension and compression strokes of the piston rod 6. When the slider 34 is placed in a position where the extension pressure control valve 21 is pressed on the valve seat 35 and the compression pressure control valve 32 is separate from the valve seat 36, it is possible to obtain “hard” damping force characteristics (large damping force) during the extension stroke and “soft” damping force characteristics during the compression stroke. When the slider 34 is placed in a position where the compression pressure control valve 32 is pressed on the valve seat 36 and the extension pressure control valve 21 is separate from the valve seat 35, it is possible to obtain “soft” damping force characteristics during the extension stroke and “hard” damping force characteristics during the compression stroke. Thus, it is possible to obtain extension/compression inverting damping force characteristics suitable for semi-active suspension control based on the sky-hook damper theory.

When the pressure of hydraulic fluid in the hydraulic fluid chambers 43 and 44 inside the hydraulic shock absorber changes sharply owing to a change in the stroke direction of the piston rod 6 or the like, the pressure is transmitted through the hydraulic fluid passage 45 in the slider 34 and also transmitted directly to the hydraulic fluid chamber 56 at the rear of the plunger 38 through the hydraulic fluid passage 47 in the actuating rod 39. At this time, because the hydraulic fluid passages 45 and 47 have a sufficiently large flow path area so that they offer substantially no flow resistance, there will be no delay in transmission of the pressure, and the pressures in the hydraulic fluid chambers 43, 44 and 56 are balanced with each other and thus kept equal to each other at all times. Therefore, there will be no undesired movement of the slider 34, the plunger 38 and the actuating rod 39 due to a pressure difference. Accordingly, stable damping force can be obtained. It should be noted that the pressures in the hydraulic fluid chambers 43, 44 and 56 are not transmitted directly to the hydraulic fluid chambers 53 and 54 at both ends of the plunger 38.

In addition, when the plunger 38 moves, the hydraulic fluid flows between the hydraulic fluid chambers 53 and 54 at both ends of the plunger 38 through the hydraulic fluid passage 58. Therefore, damping force is exerted against the movement of the plunger 38 by the flow resistance of the orifice 59. Accordingly, it is possible to suppress the movement of the plunger 38 and the actuating rod 39 due to self-induced vibration and disturbance and hence possible to obtain stable damping force.

As has been detailed above, according to the solenoid apparatus of the present invention, the hydraulic fluid chamber at the rear of the movable core is communicated directly with hydraulic fluid chambers in the hydraulic shock absorber which influence the movement of the movable core. With this arrangement, even when there is a sharp change in the pressure in the hydraulic fluid chambers inside the hydraulic shock absorber, the pressure is transmitted directly to the hydraulic fluid chamber at the rear of the movable core through the hydraulic fluid passage. Therefore, there will be no delay in transmission of the pressure, and the pressures of hydraulic fluid acting on both ends of the movable core are always kept equal to each other. Accordingly, there will be no undesired movement of the movable core due to a pressure difference. Consequently, stable damping force can be obtained at all times.

In a case where the damping device is provided, the movement of the movable core is damped by the damping device. Therefore, it is possible to suppress the movement of the movable core due to self-induced vibration and disturbance and hence possible to obtain stable damping force.

It should be noted that the present invention is not necessarily limited to the foregoing embodiments but can be modified in a variety of ways without departing from the gist of the present invention.

What is claimed is:

1. A solenoid apparatus incorporated in a hydraulic shock absorber to actuate a damping force control valve, comprising:
a coil;
a movable actuating member having opposite ends and movable in response to excitation of said coil to provide a thrust to actuate said damping force control valve; and
a first hydraulic fluid chamber formed at one of said opposite ends of the movable actuating member, wherein said hydraulic shock absorber has a second hydraulic chamber, the hydraulic pressure in which imparts a force to the other of said opposite ends of the movable actuating member, and said first and second hydraulic fluid chambers are communicated through a passage which does not create a substantial resistance to a flow therein so that pressures of hydraulic fluid in said first and second hydraulic fluid chambers are kept equal to each other at all times.

2. A solenoid apparatus according to claim 1, wherein said movable actuating member comprises a movable core and an actuating rod fixed to said movable core, said first and second hydraulic fluid chambers being formed at the opposite ends of said actuating rod, and wherein the solenoid apparatus further comprises third and fourth hydraulic fluid chambers formed at the opposite ends of said movable core and a passage with a restriction which communicates said third and fourth hydraulic fluid chambers with each other so that said restriction creates a damping force against the movement of said movable core.

3. A solenoid apparatus according to claim 2, wherein said restriction is an orifice.

4. A solenoid apparatus according to claim 2, wherein said actuating rod has opposite end portions defining said opposite ends of the actuating rod, said opposite end portions extending into said first and second hydraulic fluid chambers, respectively, and said opposite ends of the actuating rod having the equal effective areas which receive the pressure of the hydraulic fluid in said first and second hydraulic fluid chambers.

5. A damping force control type hydraulic shock absorber comprising:
a cylinder having a hydraulic fluid sealed therein;
a piston slidably fitted in said cylinder;
a piston rod connected at one end thereof to said piston, the other end of said piston rod extending to an outside of said cylinder;
a hydraulic fluid passage for passing the hydraulic fluid in response to sliding movement of said piston;
a damping force control valve for controlling damping force by controlling flow of the hydraulic fluid through said hydraulic fluid passage; and
a solenoid apparatus having a movable actuating member for actuating said damping force control valve, said movable actuating member having opposite ends,
wherein said damping force control valve is a variable pressure control valve comprising a cylindrical portion having an upstream port and a downstream port in the side wall thereof and a slider valve slidably received in the cylindrical portion and including a valve member which controls flow of the hydraulic fluid between said upstream and down stream ports by the movement of said slider valve, said valve member having an upstream end portion and a downstream end portion, said actuating member engaging said slider valve at one of said opposite ends, and
wherein first and second hydraulic fluid chambers are formed at the other of said opposite ends of said actuating member and at said downstream end portion of said valve member, respectively, said first and second hydraulic fluid chambers being communicated through a passage which does not create a substantial resistance to a flow therein so that pressures of hydraulic fluid in said first and second hydraulic fluid chambers are kept equal to each other at all times.

6. A damping force control type hydraulic shock absorber according to claim 5, wherein said passage communicating the hydraulic fluid chambers extends in said slider valve and said actuating member.

7. A damping force control type hydraulic shock absorber according to claim 5, wherein said movable actuating member comprises a movable core and an actuating rod fixed to said movable core, said solenoid apparatus further comprises third and fourth hydraulic fluid chambers formed at the opposite ends of said movable core and a passage with a restriction which communicates said third and fourth hydraulic fluid chambers with each other so that said restriction creates a damping force against the movement of said movable core.

8. A damping force control type hydraulic shock absorber according to claim 7, wherein said restriction is an orifice.

9. A damping force control type hydraulic shock absorber according to claim 7, wherein said actuating rod has opposite end portions defining said opposite ends of the actuating rod, said opposite end portions extending into said first and second hydraulic fluid chambers, respectively, and said opposite ends of the actuating rod having the equal effective areas which receive the pressure of the hydraulic fluid in said first and second hydraulic fluid chambers.

10. A damping force control type hydraulic shock absorber comprising:
a cylinder having a hydraulic fluid sealed therein;
a piston slidably fitted in said cylinder;
a piston rod connected at one end thereof to said piston, the other end of said piston rod extending to an outside of said cylinder;
a hydraulic fluid passage for passing the hydraulic fluid in response to sliding movement of said piston;
a damping force control valve for controlling damping force by controlling flow of the hydraulic fluid through said hydraulic fluid passage; and
a solenoid apparatus having a movable actuating member for actuating said damping force control valve, said movable actuating member having opposite ends,
wherein said damping force control valve is a variable pressure control valve comprising a cylindrical portion having extension side upstream and downstream ports and compression side upstream and downstream ports in the side wall thereof and a slider valve slidably received in the cylindrical portion and including extension and compression valve members each of which controls flow of the hydraulic fluid between said upstream and down stream ports by the movement of said slider valve, each of said valve members having an upstream end portion and a downstream end portion, said actuating member engaging said downstream end portion of said compression valve member at one of said opposite ends, and
wherein a first and second hydraulic fluid chambers are formed at the other of said opposite ends of the actuating member and at said downstream end portion of said extension valve member, respectively, said first and second hydraulic fluid chambers being communicated through a passage which does not create a substantial resistance to a flow therein so that pressures of hydraulic fluid in said first and second hydraulic fluid chambers are kept equal to each other at all times.

11. A damping force control type hydraulic shock absorber according to claim 10, wherein said passage communicating the hydraulic fluid chambers extends in said slider valve and said actuating member.

12. A damping force control hydraulic shock absorber according to claim 11, further comprising fifth hydraulic fluid chamber formed at the downstream end portion of said compression valve member, said passage communicating the hydraulic fluid chambers having a branch passage extending therefrom to said fifth hydraulic fluid chamber.

13. A damping force control type hydraulic shock absorber according to claim 10, wherein said movable actuating member comprises a movable core and an actuating rod fixed to said movable core, said solenoid apparatus further comprises third and fourth hydraulic fluid chambers formed at the opposite ends of said movable core and a passage with a restriction which communicates said third and fourth hydraulic fluid chambers with each other so that said restriction creates a damping force against the movement of said movable core.

14. A damping force control type hydraulic shock absorber according to claim 13, wherein said restriction is an orifice.

15. A damping force control type hydraulic shock absorber according to claim 13, wherein said actuating rod has opposite end portions defining said opposite ends of the actuating rod, said opposite end portions extending into said first and second hydraulic fluid chambers, respectively, and said opposite ends of the actuating rod having the equal effective areas which receive the pressure of the hydraulic fluid in said first and second hydraulic fluid chambers.
